(19) United States
(12) Patent Application Publication
(10) Pub. No.: US 2015/0356947 A1
(43) Pub. Date: Dec. 10, 2015

(54) DISPLAY DEVICE AND METHOD OF GENERATING DATA SIGNAL IN THE SAME

(71) Applicant: Samsung Display Co., Ltd., Yongin-City (KR)

(72) Inventors: Ji-Hye Eom, Hwaseong-si (KR); Baek-Woon Lee, Yongin-si (KR)

(21) Appl. No.: 14/536,385

(22) Filed: Nov. 7, 2014

(30) Foreign Application Priority Data
Jun. 5, 2014 (KR) 10-2014-0068677

(51) Int. Cl. G09G 5/10

(52) U.S. Cl. CPC G09G 5/10

(57) ABSTRACT

A display device and a method of generating a data signal in the same are disclosed. In one aspect, the display device includes a display panel including pixels each configured to emit light based on a data signal. The display device also includes a power supply line configured to receive a power supply voltage from a power supply, the power supply configured to apply the power supply voltage to at least one sample pixel through the power supply line. The display device further includes a data signal generator that generates the data signal based at least in part on image data, calculate a voltage drop of the power supply voltage based on a measured level of the power supply voltage, and control the data signal based at least in part on the calculated voltage drop.

### CROSS-REFERENCE TO RELATED APPLICATION

This application claims priority under 35 USC §119 to Korean Patent Application No. 2014-0068677, filed on Jun. 5, 2014 in the Korean Intellectual Property Office (KIPO), the contents of which are herein incorporated by reference in their entirety.

### BACKGROUND

1. Field

The described technology generally relates to display devices, and methods of generating data signals in the display devices.

2. Description of the Related Technology

Display devices include a display panel that includes a pixels and power supply lines providing power supply voltages to the pixels. Recently, as the size of the display panel has become larger, the lengths of the power supply lines have increased leading to corresponding increases in voltage drops. This can result in reduced luminance for pixels at greater distances from the power supply which is noticeable and undesirable.

### SUMMARY OF CERTAIN INVENTIVE ASPECTS

One inventive aspect is a display device that can accurately compensate a data signal.

Another aspect is a method of generating a data signal in a display device that can accurately compensate the data signal.

Another aspect is a display device that includes a display panel, a power supply, a power supply line, a measuring unit and a data signal generator. The display panel includes a plurality of pixels. The plurality of pixels emit based on a data signal. The power supply generates a power supply voltage. The power supply line is connected between the power supply and the plurality of pixels. The power supply line receives the power supply voltage from the power supply. The power supply voltage is applied to the plurality of pixels through the power supply line. The measuring unit measures the power supply voltage applied from the power supply line to at least one sample pixel among the plurality of pixels. The data signal generator generates the data signal based on image data, calculates a voltage drop of the power supply voltage based on the measured power supply voltage, and controls the data signal based on the voltage drop of the power supply voltage.

In an example embodiment, the data signal generator can control the data signal to compensate the voltage drop of the power supply voltage.

In an example embodiment, the power supply line can include a first line, a second line and a third line. The first line can be connected to the power supply at a first edge of the display panel and a second edge of the display panel. The first line can extend from the first and second edges of the display panel to a center of the display panel. The first edge of the display panel can correspond to the second edge of the display panel. The second line can be disposed corresponding to the first line. The second line can be connected to the plurality of pixels. The second line can extend from the center of the display panel to the first and second edges of the display panel. The third line can connect the first line with the second line at the center of the display panel.

In an example embodiment, the at least one sample pixel can be disposed corresponding to at least one of the first and second edges of the display panel.

In an example embodiment, the power supply line can include a first line. The first line can be connected to the power supply at a first edge of the display panel and a second edge of the display panel. The first line can be connected to the plurality of pixels. The first line can extend from the first and second edges of the display panel to a center of the display panel. The first edge of the display panel can correspond to the second edge of the display panel.

In an example embodiment, the at least one sample pixel can be disposed corresponding to the center of the display panel.

In an example embodiment, the power supply line can include a first line. The first line can be connected to the power supply at a first edge of the display panel. The first line can be connected to the plurality of pixels. The first line can extend from the first edge of the display panel to a second edge of the display panel. The first edge of the display panel can correspond to the second edge of the display panel.

In an example embodiment, the at least one sample pixel can be disposed corresponding to the second edge of the display panel.

In an example embodiment, the measuring unit can include a detector and an analog-to-digital converter (ADC). The detector can be connected to the at least one sample pixel. The detector can detect a level of the power supply voltage applied to the at least one sample pixel. The ADC can digitalize the measured level of the power supply voltage.

In an example embodiment, the measuring unit can further include a calculator. The calculator can calculate an average value of the digitalized level of the power supply voltage.

In an example embodiment, the data signal generator can include a voltage drop calculator, an image data processing unit and a voltage drop compensator. The voltage drop calculator can calculate the voltage drop of the power supply voltage based on the measured power supply voltage. The image data processing unit can generate the data signal based on the image data. The voltage drop compensator can control the data signal generated by the image data processing unit based on the voltage drop of the power supply voltage calculated by the voltage drop calculator.

Another aspect is a method of generating a data signal in a display device that includes a display panel, the display panel includes a plurality of pixels, and the plurality of pixels emit based on the data signal. A power supply voltage is generated by a power supply. The power supply voltage is applied to the plurality of pixels through a power supply line. The power supply voltage applied from the power supply line to at least one sample pixel among the plurality of pixels is measured. The data signal is generated based on image data. A voltage drop of the power supply voltage is calculated based on the measured power supply voltage. The data signal is controlled based on the voltage drop of the power supply voltage.

In an example embodiment, the data signal can be controlled to compensate the voltage drop of the power supply voltage.

In an example embodiment, the power supply line can include a first line, a second line and a third line. The first line can be connected to the power supply at a first edge of the display panel and a second edge of the display panel. The first line can extend from the first and second edges of the display panel to a center of the display panel. The first edge of the display panel can correspond to the second edge of the display panel. The second line can be disposed corresponding to the first line. The second line can be connected to the plurality of pixels. The second line can extend from the center of the display panel to the first and second edges of the display panel. The third line can connect the first line with the second line at the center of the display panel.

In an example embodiment, the at least one sample pixel can be disposed corresponding to at least one of the first and second edges of the display panel.

In an example embodiment, the power supply line can include a first line. The first line can be connected to the power supply at a first edge of the display panel and a second edge of the display panel. The first line can be connected to the plurality of pixels. The first line can extend from the first and second edges of the display panel to a center of the display panel. The first edge of the display panel can correspond to the second edge of the display panel.

In an example embodiment, the at least one sample pixel can be disposed corresponding to the center of the display panel.

In an example embodiment, the power supply line can include a first line. The first line can be connected to the power supply at a first edge of the display panel. The first line can be connected to the plurality of pixels. The first line can extend from the first edge of the display panel to a second edge of the display panel. The first edge of the display panel can correspond to the second edge of the display panel.

In an example embodiment, the at least one sample pixel can be disposed corresponding to the second edge of the display panel.

In an example embodiment, an average value of the measured power supply voltage can be further calculated.

Another aspect is a display device comprising a display panel including a plurality of pixels each configured to emit light based at least in part on a data signal, and a power supply configured to generate a power supply voltage. The display device also comprises a power supply line electrically connected between the power supply and the pixels and configured to receive the power supply voltage from the power supply, the power supply further configured to apply the power supply voltage to at least one sample pixel of the pixels through the power supply line. The display device further comprises a measuring unit configured to measure a level of the power supply voltage being applied to the at least one sample pixel, and a data signal generator configured to i) generate the data signal based at least in part on image data, ii) calculate a voltage drop of the power supply voltage based at least in part on the measured level of the power supply voltage, and iii) control the data signal based at least in part on the calculated voltage drop.

In the above display device, the data signal generator is further configured to control the data signal so as to compensate the calculated voltage drop of the power supply voltage.

In the above display device, the power supply line includes a first line connected to the power supply at first and second edges of the display panel and extending from the first and second edges to substantially the center of the display panel, wherein the first edge corresponds to the second edge. In the above display device, the power supply line also includes a second line corresponding to the first line and connected to the pixels, wherein the second line extends from substantially the center of the display panel to the first and second edges, and a third line connecting the first line to the second line at substantially the center of the display panel.

In the above display device, the at least one sample pixel has a location in the display panel corresponding to at least one of the first and second edges of the display panel.

In the above display device, the power supply line includes a first line connected to i) the power supply at first and second edges of the display panel and ii) the pixels, wherein the first line extends from the first and second edges to substantially the center of the display panel, and wherein the first edge corresponds to the second edge.

In the above display device, the at least one sample pixel has a location in the display panel corresponding to substantially the center of the display panel.

In the above display device, the power supply line includes a first line connected to i) the power supply at a first edge of the display panel and ii) the pixels, wherein the first line extends from the first edge of the display panel to a second edge of the display panel, and wherein the first edge corresponds to the second edge.

In the above display device, the at least one sample pixel has a location in the display panel corresponding to the second edge.

In the above display device, the measuring unit includes a detector connected to the at least one sample pixel and configured to detect a level of the power supply voltage being applied to the at least one sample pixel, and an analog-to-digital converter (ADC) configured to digitalize the measured level of the power supply voltage.

In the above display device, the measuring unit further includes a calculator configured to calculate an average value of a plurality of the digitalized levels.

In the above display device, the data signal generator includes a voltage drop calculator configured to calculate the voltage drop, an image data processor configured to generate the data signal, and a voltage drop compensator configured to control the generated data signal based at least in part on the calculated voltage drop.

Another aspect is a method of generating a data signal in a display device including a display panel, which includes a plurality of pixels each configured to emit light based at least in part on the data signal. The method comprises generating at a power supply a power supply voltage, applying the power supply voltage to at least one sample pixel of the pixels through a power supply line, measuring a level of the power supply voltage being applied to the at least one sample pixel, generating the data signal based at least in part on image data, calculating a voltage drop of the power supply voltage based at least in part on the measured power supply voltage, and controlling the data signal based at least in part on the calculated voltage drop.

In the above method, the controlled data signal compensates the calculated voltage drop of the power supply voltage.

In the above method, the power supply line includes a first line connected to the power supply at first and second edges of the display panel and extending from the first and second edges to substantially the center of the display panel, wherein the first edge corresponds to the second edge. In the above method, the power supply line also includes a second line corresponding to the first line and connected to the pixels, wherein the second line extends from substantially the center of the display panel to the first and second edges, and a third line connecting the first line to the second line at substantially the center of the display panel.

In the above method, the at least one sample pixel has a location in the display panel corresponding to at least one of the first and second edges of the display panel.

In the above method, the power supply line includes a first line connected to i) the power supply at first and second edges of the display panel, and ii) the pixels, wherein the first line extends from the first and second edges to substantially the center of the display panel, and wherein the first edge corresponds to the second edge.

In the above method, the at least one sample pixel has a location in the display panel corresponding to substantially the center of the display panel.

In the above method, the power supply line includes a first line connected to i) the power supply at a first edge of the display panel and ii) the pixels, wherein the first line extends from the first edge of the display panel to a second edge of the display panel, and wherein the first edge corresponds to the second edge.

In the above method, the at least one sample pixel has a location in the display panel corresponding to the second edge.

The above method further comprises calculating an average value of a plurality of the measured power supply voltages.

According to at least one of the disclosed embodiments, the power supply voltage that is applied to the at least one sample pixel can be measured. Accordingly, the data signal can be relatively accurately compensated based on the measured power supply voltage, and the uniformity of the luminance in the display panel of the display device can be improved.

### BRIEF DESCRIPTION OF THE DRAWINGS

FIG. 1 is a block diagram illustrating a display device according to example embodiments.

FIG. 2A is a diagram illustrating an example of a power supply line included in the display device of FIG. 1.

FIG. 2B is a diagram illustrating another example of the power supply line included in the display device of FIG. 1.

FIG. 2C is a diagram illustrating still another example of the power supply line included in the display device of FIG. 1.

FIG. 3A is a diagram for describing the voltage drop of the power supply voltage by the power supply line of FIG. 2A.

FIG. 3B is a diagram for describing the voltage drop of the power supply voltage by the power supply lines of FIGS. 2B and 2C.

FIG. 4 is a block diagram illustrating an example of a measuring unit included in the display device of FIG. 1.

FIG. 5 is a block diagram illustrating an example of a data signal generator included in the display device of FIG. 1.

FIG. 6 is a flowchart illustrating a method of generating a data signal in a display device according to example embodiments.

### DETAILED DESCRIPTION OF CERTAIN INVENTIVE EMBODIMENTS

Voltage drops in power supply voltages of display devices can occur. When the power supply voltages with different levels are applied to the pixels, luminance of the display panel can vary. Providing the power supply voltages with the same level to the pixels can be an expensive solution. Thus, a method by which data signals are differentially compensated according to the degrees of the voltage drops has been suggested. However, in this method, the power supply voltages are calculated based on the data signals. And if the data signals are compensated with errors, the non-uniformity of the luminance can also occur due to the data signals compensated with the errors.

Hereinafter, embodiments will be explained in detail with reference to the accompanying drawings Like or similar reference numerals refer to like or similar elements throughout. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

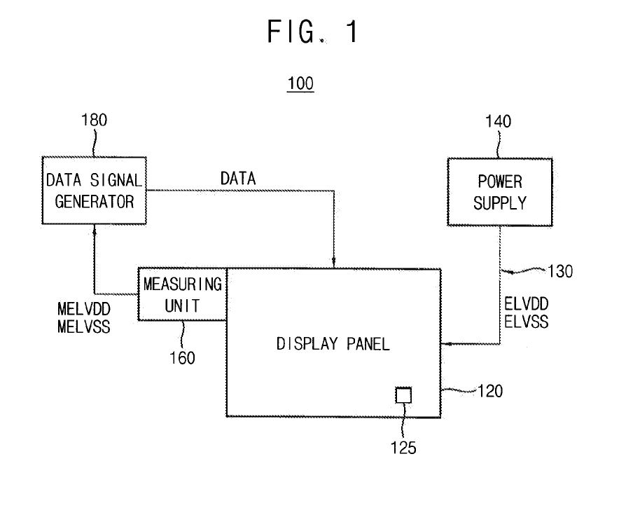

FIG. 1 is a block diagram illustrating a display device according to example embodiments.

Referring to FIG. 1, a display device 100 includes a display panel 120, a power supply line 130, a power supply 140, a measuring unit 160 and a data signal generator 180.

The display panel 120 includes a pixels 125. The pixels 125 emit light based on a data signal DATA. The power supply 140 generates power supply voltages ELVDD and ELVSS. The power supply voltages ELVDD and ELVSS are applied to the pixels 125 in the display panel 120 through the power supply line 130.

The data signal DATA can have grayscale information of an image to be displayed on the display panel 120. The data signal DATA can be applied to the pixels 125 based on a scan signal. In an analog driving method, luminance of the pixels 125 can be controlled based on a voltage level of the data signal DATA. For example, to display one of three different grayscales in the analog driving method, the data signal DATA has one of three different levels, e.g., one of about 1V, 2V and 3V. In a digital driving method, the luminance of the pixels 125 can be controlled based on the number of enabled sub-frames among a sub-frames included in the data signal DATA. For example, to display different grayscales in the digital driving method, the data signal DATA includes the sub-frames. In this example, each sub-frame has one of ON/OFF levels, e.g., about 0V and about 5V, and the number of the enabled sub-frames (e.g. sub-frames having the ON level) in the data signal DATA changes. Although the examples of the data signal DATA are described above based on the driving method, it is not limited thereto.

The pixels 125 can emit light based on the data signal DATA and the power supply voltages ELVDD and ELVSS. As described above, the luminance of the pixels 125 can be controlled based on the voltage level of the data signal DATA or the number of the enabled sub-frames in the data signal DATA. However, the luminance of the pixels 125 can also vary if levels of the power supply voltages ELVDD and ELVSS change. For example, even if the voltage level of the data signal DATA is maintained at about 1V, current flowing through the pixels 125 changes when the power supply voltage ELVDD is changed from about 3V to about 3.5V, and thus the luminance of the pixels 125 varies based on the changed power supply voltage ELVDD. Although the examples of the voltage level of the data signal DATA and the level of the power supply voltage ELVDD are described above, they are not limited thereto.

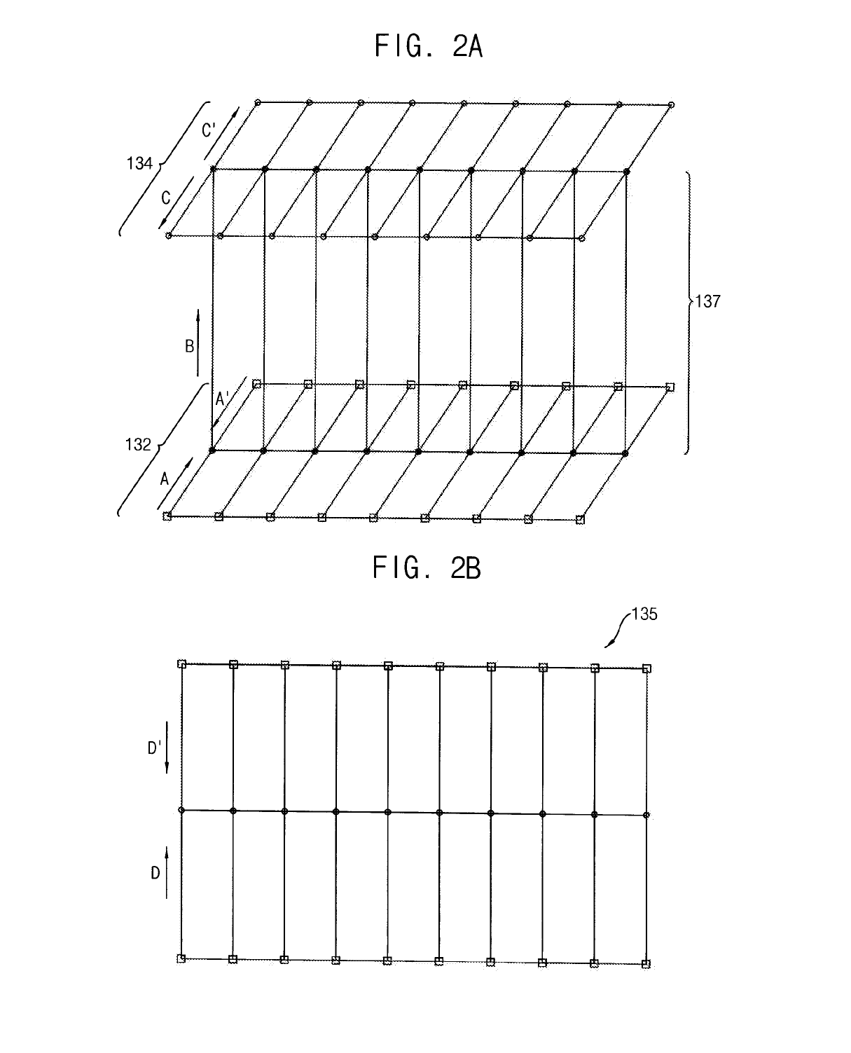

The power supply line 130 is connected between the power supply 140 and the pixels 125. The power supply line 130 receives the power supply voltages ELVDD and ELVSS from the power supply 140. The power supply voltages ELVDD and ELVSS are applied to the pixels 125 through the power supply line 130. The voltage drops of the power supply voltages ELVDD and ELVSS can occur due to, e.g., a resistance of the power supply line 130. As the size of the display panel 120 has become larger, the length of the power supply line 130 has increased, and thus the power supply voltages ELVDD and ELVSS can drop greatly. The power supply voltages ELVDD and ELVSS with different levels can be applied to the pixels 125, and then the non-uniformity of luminance can occur in the display panel 120. Detailed configurations of the power supply line 130 will be described with reference to FIGS. 2A, 2B and 2C.

The measuring unit 160 measures the power supply voltages ELVDD and ELVSS applied from the power supply line 130 to at least one sample pixel among the pixels 125. The at least one sample pixel can be selected based on various conditions, such as a size of the display panel 120, locations of the pixels in the display panel 120, etc. In some example embodiments, the at least one sample pixel is the same for all of the pixels 125. The power supply voltages ELVDD and ELVSS can be efficiently compensated as the number of the at least one sample pixel increases. In other example embodiments, the at least one sample pixel is the farthest pixel from the power supply 140. The voltage drops of the power supply voltages ELVDD and ELVSS are typically the worst for the farthest pixel. For example, the levels of the power supply voltages ELVDD and ELVSS applied to the farthest pixel can be lowest.

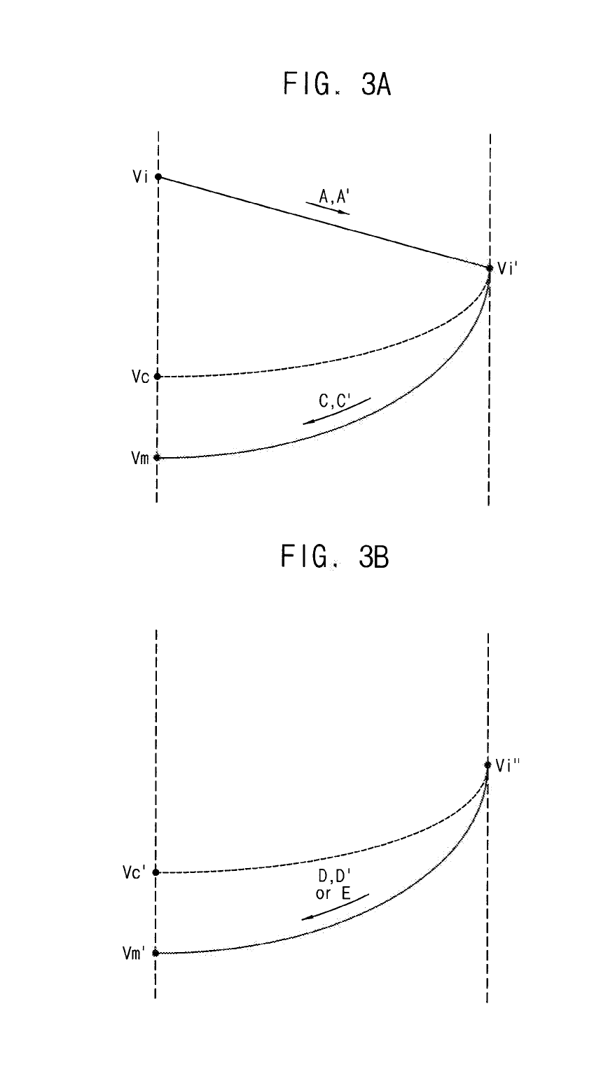

In some example embodiments, the measuring unit 160 includes a detector, an analog-to-digital converter (ADC) and a calculator. Detailed configuration of the measuring unit 160 will be described with reference to FIG. 4.

The data signal generator 180 generates the data signal DATA based on image data. The data signal generator 180 calculates the voltage drops of the power supply voltages ELVDD and ELVSS based at least in part on the measured power supply voltages MELVDD and MELVSS. The data signal generator 180 controls the data signal DATA based on the voltage drops of the power supply voltages ELVDD and ELVSS.

The data signal generator 180 can receive the image data from an external host (e.g., CPU, GPU, etc.). In some embodiments, the image data is not appropriate to drive the pixels 125, and thus the data signal generator 180 generates the data signal DATA that is appropriate to drive the pixels 125 based at least in part on the image data.

The data signal generator 180 can calculate the voltage drops of the power supply voltages ELVDD and ELVSS. As described above, the levels of the power supply voltages ELVDD and ELVSS applied to the at least one sample pixel can be directly obtained by the measuring unit 160. In addition, the levels of the power supply voltages ELVDD and ELVSS applied to the other pixels except the at least one sample pixel will be obtained by the calculating operation of the data signal generator 180.

In some example embodiments, the levels of the power supply voltages ELVDD and ELVSS applied to the other pixels except the at least one sample pixel is calculated by solving a set of linear equations based at least in part on the power supply voltages ELVDD and ELVSS having initial levels and the measured power supply voltages MELVDD and MELVSS. For example, the data signal generator 180 includes a look-up table that has equations converted into a matrix form.

In some example embodiments, the data signal generator 180 controls the data signal DATA so as to compensate the voltage drops of the power supply voltages ELVDD and ELVSS. The data signal generator 180 can control the data signal DATA so as to compensate the difference between displayed luminance of the pixels 125 and target luminance of the pixels 125. For example, if the voltage drop of the power supply voltage ELVDD is about 0.1V and the displayed luminance is reduced from the target luminance by about 10 nits, the luminance difference is compensated by increasing the data signal DATA and current flowing through the pixels 125. Although the examples of the voltage drop and the luminance difference are described above, they are not limited thereto.

In some example embodiments, the data signal DATA generated by the data signal generator 180 is applied to the pixels 125 based on the scan signal. A timing controller included in the data signal generator 180 can serially generate and control the data signal DATA in serial. A data driving unit included in the data signal generator 180 can provide the data signal DATA to the pixels 125 in parallel based on the scan signal.

As described above, the display device 100 includes the display panel 120, the power supply line 130, the power supply 140, the measuring unit 160 and the data signal generator 180. The measuring unit 160 measures the power supply voltages ELVDD and ELVSS applied from the power supply line 130 to the at least one sample pixel. Accordingly, the data signal DATA can be relatively accurately compensated based at least in part on the measured power supply voltages MELVDD and MELVSS, and the uniformity of the luminance in the display panel 120 can be improved.

FIG. 2A is a diagram illustrating an example of the power supply line 130 included in the display device 100 of FIG. 1.

Referring to FIGS. 1 and 2A, the power supply line 130 include first to third lines 132, 134 and 137. The first line 132 is connected to the power supply 140 at first and second edges of the display panel 120. The first edge corresponds to the second edge, and the first and second edges of the display panel 120 are illustrated as white squares in FIG. 2A. The first line 132 can extend from the first and second edges to the center of the display panel 120 (e.g., extend in directions A and A′). The center of the display panel 120 are illustrated as black circles in FIG. 2A. The second line 134 is formed corresponding to the first line 132. The second line 134 can be connected to the pixels 125. The second line 134 can extend from the center of the display panel 120 to the first and second edges (e.g., can extend in directions C and C′). The third line 137 connects the first line 132 to the second line 134 at the center of the display panel 120.

The first line 132 can receive the power supply voltage generated by the power supply 140. The power supply voltage can be provided from the first and second edges to the center of the display panel 120 (e.g., in the directions A and A′) through the first line 132. The power supply voltage can be provided from the first line 132 to the second line 134 (e.g., in a direction B) through the third line 137. In addition, the power supply voltage can be provided from the center of the display panel 120 to the first and second edges (e.g., in the directions C and C′) through the second line 134. The pixels 125 can be connected to the second line 134 and can be formed on the second line 134. The pixels 125 can receive the power supply voltage through the second line 134.

For example, a first pixel among the pixels 125 is formed corresponding to at least one of the first and second edges. A second pixel among the pixels 125 can be formed corresponding to the center of the display panel 120. Positions of the first pixel are illustrated as white circles on the second line 134 in FIG. 2A, and positions of the second pixel are illustrated as black circles on the second line 134 in FIG. 2A.

In some example embodiments, a first level of the power supply voltage applied to the first pixel is lower than a second level of the power supply voltage applied to the second pixel due to the voltage drop. As described above, the power supply voltage can be provided through the first line 132 in the directions A and A′, through the third line 137 in the direction B, and through the second line 134 in the directions C and C′. The lengths of the lines for providing the power supply voltage to the first pixel can be longer than the lengths of the lines for providing the power supply voltage to the second pixel, and thus the voltage drop of the power supply voltage applied to the first pixel can be worse than the voltage drop of the power supply voltage applied to the second pixel.

In some example embodiments, the at least one sample pixel among the pixels 125 is formed corresponding to at least one of the first and second edges. For example, the first pixel can be the at least one sample pixel, and positions of the at least one sample pixel are illustrated as white circles on the second line 134 in FIG. 2A. The measuring unit 160 measures the power supply voltage applied to the at least one sample pixel.

As described above, the levels of the power supply voltage applied to the other pixels among the pixels 125 except the at least one sample pixel will be obtained by the data signal generator 180. In addition, since the at least one sample pixel is formed corresponding to at least one of the first and second edges, the measuring unit 160 can be relatively easily employed by being located adjacent to the first and second edges.

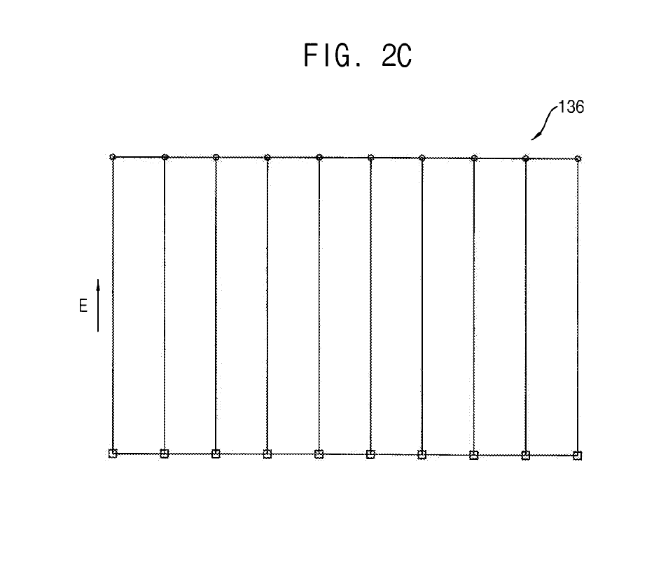

An example of the voltage drop of the power supply voltage by the first to third lines 132, 134 and 137 will be described in detail with reference to FIG. 3A.

FIG. 2B is a diagram illustrating another example of the power supply line 130 included in the display device of FIG. 1.

Referring to FIGS. 1 and 2B, the power supply line 130 include a fourth line 135. The fourth line 135 can be connected to the power supply 140 at the first and second edges. The first and second edges are illustrated as white squares in FIG. 2B. The fourth line 135 can be connected to the pixels 125. The fourth line 135 can extend from the first and second edges to the center of the display panel 120 (e.g., in directions D and D′). The center of the display panel 120 are illustrated as white circles in FIG. 2B.

The fourth line 135 can receive the power supply voltage generated by the power supply 140. The power supply voltage can be provided from the first and second edges to the center of the display panel 120 (e.g., in the directions D and D′) through the fourth line 135. The pixels 125 can be connected to the fourth line 135 and can be formed on the fourth line 135. The pixels 125 can receive the power supply voltage through the fourth line 135.

For example, a third pixel among the pixels 125 is formed corresponding to at least one of the first and second edges. A fourth pixel among the pixels 125 can be formed corresponding to the center of the display panel 120. Positions of the third pixel are illustrated as white squares on the fourth line 135 in FIG. 2B, and positions of the fourth pixel are illustrated as white circles on the fourth line 135 in FIG. 2B.

In some example embodiments, a third level of the power supply voltage applied to the third pixel is higher than a fourth level of the power supply voltage applied to the fourth pixel. For example, the fourth level of the power supply voltage is lower than the third level of the power supply voltage due to the voltage drop. As described above, the power supply voltage can be provided through the fourth line 135 in the directions D and D′. The length of the lines for providing the power supply voltage to the fourth pixel can be longer than the length of the lines for providing the power supply voltage to the third pixel, and thus the voltage drop of the power supply voltage applied to the fourth pixel can be worse than the voltage drop of the power supply voltage applied to the third pixel.

In some example embodiments, the at least one sample pixel among the pixels 125 is formed corresponding to the center of the display panel 120. For example, the fourth pixel can be the at least one sample pixel, and positions of the at least one sample pixel are illustrated as white circles on the fourth line 135 in FIG. 2B. The measuring unit 160 measures the power supply voltage applied to the at least one sample pixel.

As described above, the levels of the power supply voltage applied to the other pixels among the pixels 125 except the at least one sample pixel will be obtained by the data signal generator 180.

An example of the voltage drop of the power supply voltage by the fourth line 135 will be described in detail with reference to FIG. 3B.

FIG. 2C is a diagram illustrating still another example of the power supply line 130 included in the display device of FIG. 1.

Referring to FIGS. 1 and 2C, the power supply line 130 includes a fifth line 136. The fifth line 136 can be connected to the power supply 140 at the first edge. The fifth line 136 can be connected to the pixels 125. The fifth line 136 can extend from the first edge to the second edge (e.g., in a direction E). The first edge can correspond to the second edge. The first edge is illustrated as white squares in FIG. 2C, and the second edge is illustrated as white circles in FIG. 2C.

The fifth line 136 can receive the power supply voltage generated by the power supply 140. The power supply voltage can be provided from the first edge to the second edge (e.g., in the direction E) through the fifth line 136. The pixels 125 can be connected to the fifth line 136 and can be formed on the fifth line 136. The pixels 125 can receive the power supply voltage through the fifth line 136.

For example, a fifth pixel among the pixels 125 is formed corresponding to the first edge. A sixth pixel among the pixels 125 can be formed corresponding to the second edge. Positions of the fifth pixel are illustrated as white squares on the fifth line 136 in FIG. 2C, and positions of the sixth pixel are illustrated as white circles on the fifth line 136 in FIG. 2C.

In some example embodiments, a fifth level of the power supply voltage applied to the fifth pixel is higher than a sixth level of the power supply voltage applied to the sixth pixel. For example, the sixth level of the power supply voltage is lower than the fifth level of the power supply voltage due to the voltage drop. As described above, the power supply voltage can be provided through the fifth line 136 in the direction E. The length of the lines for providing the power supply voltage to the sixth pixel can be longer than the length of the lines for providing the power supply voltage to the fifth pixel, and thus the voltage drop of the power supply voltage applied to the sixth pixel can be worse than the voltage drop of the power supply voltage applied to the fifth pixel.

In some example embodiments, the at least one sample pixel among the pixels 125 can be formed corresponding to the second edge. For example, the sixth pixel is the at least one sample pixel, and positions of the at least one sample pixel are illustrated as white circles on the fifth line 136 in FIG. 2C. The measuring unit 160 measures the power supply voltage applied to the at least one sample pixel.

As described above, the levels of the power supply voltage applied to the other pixels except the at least one sample pixel will be obtained by the data signal generator 180. In addition, since the at least one sample pixel is formed corresponding to the second edge, the measuring unit 160 can be relatively easily employed by being located adjacent to the second edge.

An example of the voltage drop of the power supply voltage by the fifth line 136 will be described in detail with reference to FIG. 3B.

FIG. 3A is a diagram for describing the voltage drop of the power supply voltage by the power supply line of FIG. 2A.

Referring to FIGS. 2A and 3A, the power supply voltage has an initial level Vi at the first and second edges of the first line 132 (e.g., at the white squares on the first line 132 in FIG. 2A). As the power supply voltage is provided in the directions A and A′, the level of the power supply voltage substantially linearly decreases due to a resistance of the first line 132. Thus, the power supply voltage can have a level Vi, which is lower than the initial level Vi, at the center of the first line 132 (e.g., at the black circles on the first line 132 in FIG. 2A).

If the length of the third line 137 is extremely shorter than lengths of the first and second lines 132 and 134, the voltage drop of the power supply voltage by the third line 137 can be negligible. Thus, the power supply voltage can also have the level Vi at the center of the second line 134 (e.g., at the black circles on the second line 134 in FIG. 2A). As the power supply voltage is provided in the directions C and C′, the level of the power supply voltage decreases due to a resistance of the second line 134 and power consumption by the pixels connected to the second line 134.

There can be a difference (e.g., an error) between a calculated voltage drop of the power supply voltage (e.g., a dashed line from the level Vi to a level Vc in FIG. 3A) and the measured voltage drop of the power supply voltage (e.g., a solid line from the level Vi to a level Vm in FIG. 3A). The difference can be the largest at the first and second edges of the second line 134 (e.g., at the white circles on the second line 134 in FIG. 2A). Thus, in the power supply line of FIG. 2A, the data signal can be relatively accurately compensated when the voltage drop of the power supply voltage is measured from the at least one sample pixel that is formed corresponding to the at least one of the first and second edges of the display panel 120.

FIG. 3B is a diagram for describing the voltage drop of the power supply voltage by the power supply lines of FIGS. 2B and 2C.

Referring to FIGS. 2B and 3B, the power supply voltage has an initial level Vi″ at the first and second edges of the fourth line 135 (e.g., at white squares on the fourth line 135 in FIG. 2B). As the power supply voltage is provided in the directions D and D′, the level of the power supply voltage can decrease due to a resistance of the fourth line 135 and power consumption by the pixels connected to the fourth line 135.

There can be a difference between a calculated voltage drop of the power supply voltage (e.g., a dashed line from the initial level Vi″ to a level Vc′ in FIG. 3B) and the measured voltage drop of the power supply voltage (e.g., a solid line from the initial level Vi″ to a level Vm′ in FIG. 3B). The difference can be the largest at the center of the fourth line 135 (e.g., at white circles on the fourth line 135 in FIG. 2B). Thus, in the power supply line of FIG. 2B, the data signal can be relatively accurately compensated when the voltage drop of the power supply voltage is measured from the at least one sample pixel that is formed corresponding to the center of the display panel 120.

Similarly, referring to FIGS. 2C and 3B, the power supply voltage has the initial level Vi″ at the first edge of the fifth line 136 (e.g., at the white squares on the fifth line 136 in FIG. 2C). As the power supply voltage is provided in the direction E, the level of the power supply voltage decreases due to a resistance of the fifth line 136 and power consumption by the pixels connected to the fifth line 136.

There can be the difference between the calculated voltage drop of the power supply voltage (e.g., the dashed line from the initial level Vi″ to the level Vc′ in FIG. 3B) and the measured voltage drop of the power supply voltage (e.g., the solid line from the initial level Vi″ to the level Vm′ in FIG. 3B). The difference can be largest at the second edge of the fifth line 136 (e.g., at the white circles on the fifth line 136 in FIG. 2C). Thus, in the power supply line of FIG. 2C, the data signal can be relatively accurately compensated when the voltage drop of the power supply voltage is measured from the at least one sample pixel that is formed corresponding to the second edge of the display panel 120.

FIG. 4 is a block diagram illustrating an example of the measuring unit 160 included in the display device 100 of FIG. 1.

Referring to FIG. 4, the measuring unit 160 includes detectors 162a, 162b, . . . , 162c, and analog-to-digital converters (ADCs) 164a, 164b, . . . , 164c. The measuring unit 160 further includes a calculator 166.

Each of the detectors 162a, 162b, . . . , 162c can be connected to the at least one sample pixel. Each of the detectors 162a, 162b, . . . , 162c can detect a level of the power supply voltage applied to the at least one sample pixel. For example, the detectors 162a, 162b, . . . , 162c are formed on a film, e.g. a form of a chip-on film (COF). The ADCs 164a, 164b, . . . , 164c can digitalize the measured levels VA1, VA2, . . . , VA3 of the power supply voltage.

The calculator 166 can calculate an average value of the digitalized levels VD1, VD2, . . . , VD3 of the power supply voltage so as to generate the measured power supply voltages MELVDD and MELVSS. In some example embodiments, the calculator 166 calculates the average value based on all of the sample pixels. In other example embodiments, the calculator 166 calculates the average value based on some of the sample pixels.

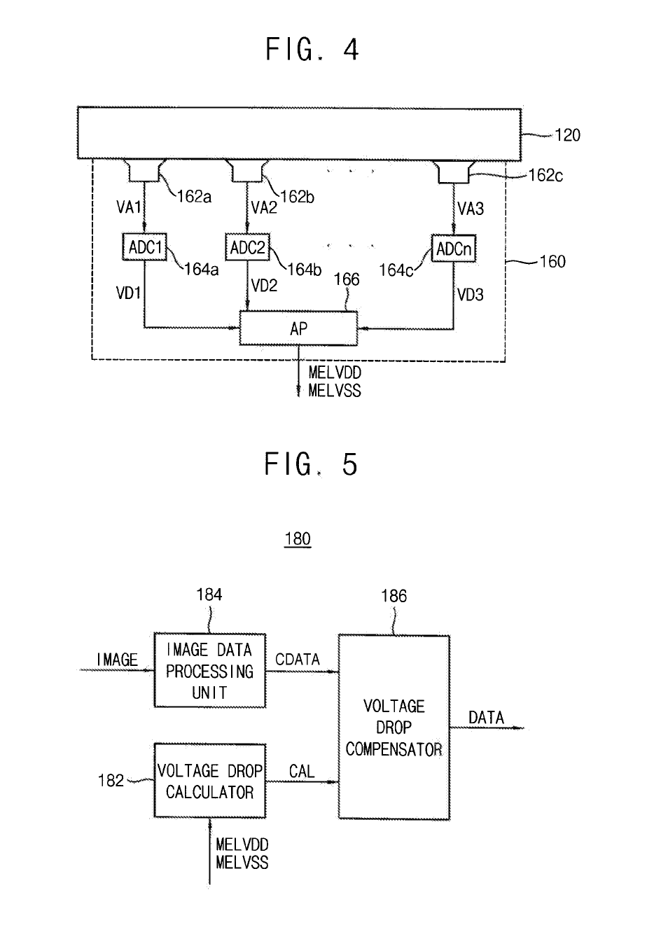

FIG. 5 is a block diagram illustrating an example of a data signal generator 180 included in the display device 100 of FIG. 1.

Referring to FIG. 5, a data signal generator 180 includes a voltage drop calculator 182, an image data processing unit or image data processor 184 and a voltage drop compensator 186.

As described above, the levels of the power supply voltages ELVDD and ELVSS applied to the other pixels except the at least one sample pixel can be obtained by the data signal generator 180. The voltage drop calculator 182 calculates the voltage drops of the power supply voltages ELVDD and ELVSS so as to generate a calculating result CAL.

The image data processing unit 184 can generate the data signal DATA that is not compensated based on the image data IMAGE. The voltage drop compensator 186 can control the data signal DATA. The voltage drop compensator 186 can generate the compensated data signal CDATA based at least in part on the calculating result CAL.

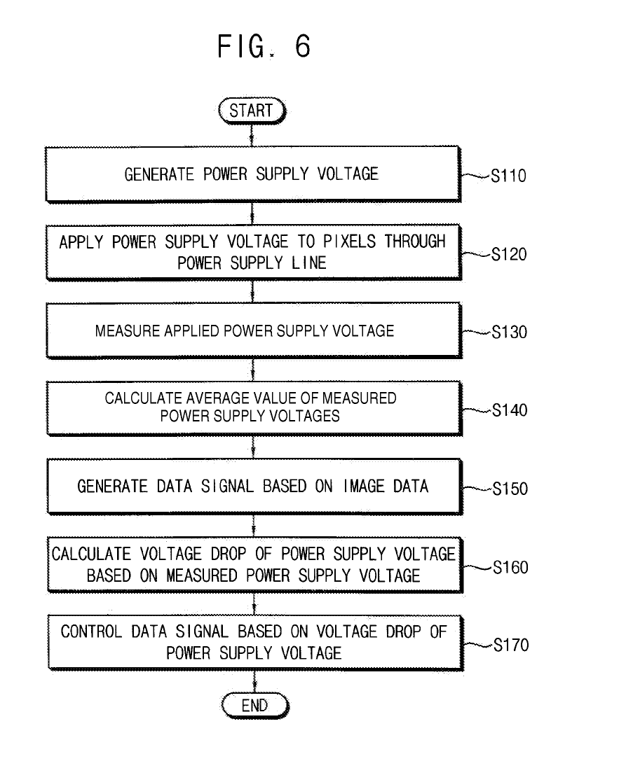

FIG. 6 is a flowchart illustrating a method of generating a data signal in a display device according to example embodiments.

Referring to FIG. 6, in a method of generating a data signal in a display device according to example embodiments, a power supply voltage is generated (step S110). The power supply voltage is applied to the pixels through a power supply line (step S120). The power supply voltage applied from the power supply line to at least one sample pixel among the pixels is measured (step S130). The data signal is generated based on image data (step S150). A voltage drop of the power supply voltage is calculated based on the measured power supply voltage (step S160). The data signal is controlled based on the voltage drop of the power supply voltage (step S170). In some example embodiments, an average value of the measured power supply voltage is further calculated (step S140).

In steps S110 and S120, the power supply voltage is generated by a power supply and applied to the pixels included in the display panel through the power supply line.

In step S130, the at least one sample pixel is selected based on various conditions, such as the size of the display panel, locations of the pixels in the display panel, etc. In some example embodiments, the at least one sample pixel includes all of the pixels. The power supply voltage can be efficiently compensated as the number of the at least one sample pixel increases. In other example embodiments, the at least one sample pixel can include the farthest pixel from the power supply, and the voltage drop of the power supply voltage can be worst in the farthest pixel. For example, a level of the power supply voltage applied to the farthest pixel is the lowest.

In step S150, the image data is received from an external host (e.g., CPU, GPU, etc.). In some embodiments, the image data is not appropriate to drive the pixels, and thus the data signal that is appropriate to drive the pixels is generated based on the image data. The data signal can be applied to the pixels based on a scan signal.

In step S160, a level of the power supply voltage applied to the at least one sample pixel can be directly obtained by the step S130. Levels of the power supply voltage applied to the other pixels except the at least one sample pixel will be obtained by the calculating operation in the step S160.

In some example embodiments, the levels of the power supply voltage applied to the other pixels except the at least one sample pixel is calculated by solving a set of linear equations based on an initial power supply voltage and the measured power supply voltage. For example, the display device includes a look-up table that has equations converted into a matrix form.

In step S170, the data signal is controlled so as to compensate the voltage drop of the power supply voltage. The data signal is controlled so as to compensate the difference between displayed luminance of the pixels and target luminance of the pixels. For example, the luminance difference is compensated by increasing the data signal and current flowing through the pixels.

In the step S140, the average value is further calculated based on all of the sample pixels or some of the sample pixels.

Although it is described above that the described technology includes the power supply line formed with respect to an upper surface and/or a lower surface of the display panel, types and configurations of the power supply line is not limited thereto.

The described technology can be applied to an electronic device having a display device. For example, the described technology can be applied to a television, a computer monitor, a laptop computer, a digital camera, a cellular phone, a smartphone, a tablet computer, a personal digital assistant (PDA), a portable multimedia player (PMP), a MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel including a plurality of pixels each configured to emit light based at least in part on a data signal;
a power supply configured to generate a power supply voltage;
a power supply line electrically connected between the power supply and the pixels and configured to receive the power supply voltage from the power supply, the power supply further configured to apply the power supply voltage to at least one sample pixel of the pixels through the power supply line;
a measuring unit configured to measure a level of the power supply voltage being applied to the at least one sample pixel; and
a data signal generator configured to i) generate the data signal based at least in part on image data, ii) calculate a voltage drop of the power supply voltage based at least in part on the measured level of the power supply voltage, and iii) control the data signal based at least in part on the calculated voltage drop.

2. The display device of claim 1, wherein the data signal generator is further configured to control the data signal so as to compensate the calculated voltage drop of the power supply voltage.

3. The display device of claim 1, wherein the power supply line includes:
a first line connected to the power supply at first and second edges of the display panel and extending from the first and second edges to substantially the center of the display panel, and wherein the first edge corresponds to the second edge;
a second line corresponding to the first line and connected to the pixels, wherein the second line extends from substantially the center of the display panel to the first and second edges; and
a third line connecting the first line to the second line at substantially the center of the display panel.

4. The display device of claim 3, wherein the at least one sample pixel has a location in the display panel corresponding to at least one of the first and second edges of the display panel.

5. The display device of claim 1, wherein the power supply line includes:
a first line connected to i) the power supply at first and second edges of the display panel and ii) the pixels, wherein the first line extends from the first and second edges to substantially the center of the display panel, and wherein the first edge corresponds to the second edge.

6. The display device of claim 5, wherein the at least one sample pixel has a location in the display panel corresponding to substantially the center of the display panel.

7. The display device of claim 1, wherein the power supply line includes:
a first line connected to i) the power supply at a first edge of the display panel and ii) the pixels, wherein the first line extends from the first edge of the display panel to a second edge of the display panel, and wherein the first edge corresponds to the second edge.

8. The display device of claim 7, wherein the at least one sample pixel has a location in the display panel corresponding to the second edge.

9. The display device of claim 1, wherein the measuring unit includes:
a detector connected to the at least one sample pixel and configured to detect a level of the power supply voltage being applied to the at least one sample pixel; and
an analog-to-digital converter (ADC) configured to digitalize the measured level of the power supply voltage.

10. The display device of claim 9, wherein the measuring unit further includes:
a calculator configured to calculate an average value of a plurality of the digitalized levels.

11. The display device of claim 1, wherein the data signal generator includes:
a voltage drop calculator configured to calculate the voltage drop;
an image data processor configured to generate the data signal; and
a voltage drop compensator configured to control the generated data signal based at least in part on the calculated voltage drop.

12. A method of generating a data signal in a display device including a display panel, which includes a plurality of pixels each configured to emit light based at least in part on the data signal, the method comprising:
generating at a power supply a power supply voltage;
applying the power supply voltage to at least one sample pixel of the pixels through a power supply line;
measuring a level of the power supply voltage being applied to the at least one sample pixel;
generating the data signal based at least in part on image data;
calculating a voltage drop of the power supply voltage based at least in part on the measured power supply voltage; and
controlling the data signal based at least in part on the calculated voltage drop.

13. The method of claim 12, wherein the controlled data signal compensates the calculated voltage drop of the power supply voltage.

14. The method of claim 12, wherein the power supply line includes:
a first line connected to the power supply at first and second edges of the display panel and extending from the first and second edges to substantially the center of the display panel, and wherein the first edge corresponds to the second edge;
a second line corresponding to the first line and connected to the pixels, wherein the second line extends from substantially the center of the display panel to the first and second edges; and
a third line connecting the first line to the second line at substantially the center of the display panel.

15. The method of claim 14, wherein the at least one sample pixel has a location in the display panel corresponding to at least one of the first and second edges of the display panel.

16. The method of claim 12, wherein the power supply line includes:
a first line connected to i) the power supply at first and second edges of the display panel, and ii) the pixels, wherein the first line extends from the first and second edges to substantially the center of the display panel, and wherein the first edge corresponds to the second edge.

17. The method of claim 16, wherein the at least one sample pixel has a location in the display panel corresponding to substantially the center of the display panel.

18. The method of claim 12, wherein the power supply line includes:
a first line connected to i) the power supply at a first edge of the display panel and ii) the pixels, wherein the first line extends from the first edge of the display panel to a second edge of the display panel, and wherein the first edge corresponds to the second edge.

19. The method of claim 18, wherein the at least one sample pixel has a location in the display panel corresponding to the second edge.

20. The method of claim 12, further comprising:
calculating an average value of a plurality of the measured power supply voltages.
